(19) United States
(12) Patent Application Publication
(10) Pub. No.: US 2013/0002039 A1
(43) Pub. Date: Jan. 3, 2013

(54) NON-CONTACT CONNECTOR

(75) Inventor: Hideki Kusamitsu, Tokyo (JP)

(73) Assignee: YAMAICHI ELECTRONICS CO., LTD., Tokyo (JP)

(21) Appl. No.: 13/582,586

(22) PCT Filed: Dec. 24, 2010
(86) PCT No.: PCT/JP2010/007530

§ 371 Date: Sep. 4, 2012

(30) Foreign Application Priority Data
Mar. 5, 2010 (JP) 2010-049050

(51) Int. Cl. H01F 38/14

(52) U.S. Cl. 307/104

(57) ABSTRACT

A receiving unit portion and a transmission unit portion are brought close to each other. Then, when upper end surfaces of protrusions (18BD) are brought into contact with a surface of a reception side wiring board (30A) at a given pressure attributed to an elastic force of a flexible wiring board (18B), a gap between an electrode pad (18bi) and an electrode pad (30ai) is limited at a predetermined value by the protrusions (18BD).

### TECHNICAL FIELD

The present invention relates to a non-contact connector applicable to a capacitive coupling type and an electromagnetic induction coupling type.

### BACKGROUND ART

As shown in Japanese Patent Laid-Open No. H08-149054 (1996), for example, a non-contact connector of a so-called electromagnetic induction coupling type has been proposed for data transmission and reception portions of a pair of memory cards connected to each other. Furthermore, such memory cards are inserted into a read-write device, for example.

This non-contact connector for each of the memory cards is provided with multiple write coils and read coils alternately formed on a straight line along an end portion of the memory card, and is provided with a write control coil and a read control coil, for example.

The write coils on one of the memory cards and the read coils on the other memory card are arranged opposite to each other and are electromagnetically-induced to each other.

Herewith, the read-write device writes data to one of the memory cards through excitation of the write coils that occurs upon receipt of write control pulses transmitted via the write control coil, whereas the read-write device reads data into the memory card through excitation of the read coils that occurs upon receipt of read control pulses transmitted via the read control coil.

In addition, as shown in Japanese Patent Laid-Open No. 2000-134809, for example, a non-contact connector of a so-called capacitive coupling type has been proposed for a charging device configured to supply power from high-frequency power source to a charging circuit.

For example, this non-contact connector comprises a pair of parallel transmission lines connected to the high-frequency power source and provided with a terminator, a protection sheet serving as a dielectric body covering the pair of parallel transmission lines, and a pair of electrodes constituting part of the charging circuit inside an antitheft tag placed opposite to the protection sheet.

The pair of electrodes are connected to a high-capacity capacitor.

Hereby, through the capacitive coupling of the pair of parallel transmission lines to the pair of electrodes, a current from the electrodes in the charging circuit is charged in the high-capacity capacitor after flowing through a resonance coil, a direct-current choke coil, and a rectifier diode.

### CITATION LIST

### Patent Literature

PTL 1: Japanese Patent Laid-Open No. H08-149054 (1996)

PTL 2: Japanese Patent Laid-Open No. 2000-134809

### SUMMARY OF INVENTION

Because in the non-contact connector of any of the capacitive coupling type and the electromagnetic induction coupling type as described above, quality of a transmitted signal (a transmission error rate) is highly dependent on a mutual distance between the pair of electrodes (the write coil and the read coil), the non-contact connector requires a structure that keeps the mutual distance constant.

However, in the case of a non-contact connector required to include an increased number of transmission channels with electrodes arranged densely on two boards of the connector, the above-mentioned mutual distance needs to be extremely narrowed, and therefore it is difficult in manufacturing to achieve such extremely narrowed mutual distance in the non-contact connector only by relying on mechanical accuracy. Currently, for a miniaturized non-contact connector, a simple structure to reliably maintain the above-mentioned mutual distance at a predetermined value is nowhere to find.

In view of the above-described problems, the present invention aims to provide a non-contact connector applicable to a capacitive coupling type and an electromagnetic induction coupling type. The non-contact connector can keep a mutual distance between opposed electrode portions constant so as to hold a steady and good quality of a transmitted signal.

To achieve the above-mentioned object, a non-contact connector according to the present invention comprises: a transmission unit portion configured to transmit a supplied group of signals via a transmission chip and a coupling component; and a receiving unit portion configured to receive the group of signals from the transmission unit portion via a coupling component and a receiving chip, wherein the coupling component of at least one of the transmission unit portion and the receiving unit portion is formed on a flexible wiring board placed between the transmission chip and the receiving chip, the flexible wiring board connected to one of the transmission chip and the receiving chip, and biased in one direction by elastic means; and the flexible wiring board is provided with gap limiting means for limiting a gap between the coupling component of the transmission unit portion and the coupling component of the receiving unit portion at a predetermined distance.

According to the non-contact connector of the present invention, the gap limiting means for limiting the gap between the coupling component of the transmission unit portion and the coupling component of the receiving unit portion at the predetermined distance is provided on the flexible wiring board which is biased in one direction by the elastic means. Therefore, it is possible to keep a mutual distance between opposed electrode portions constant so as to hold a steady and good quality of a transmitted signal.

### BRIEF DESCRIPTION OF DRAWINGS

FIG. 1 is a configuration drawing schematically showing a configuration of an example of a non-contact connector according to the present invention;

FIG. 2A is a cross-sectional view partially showing a configuration of a main part of another example of the non-contact connector according to the present invention;

FIG. 2B is a partial cross-sectional view showing an exploded configuration of the example shown in FIG. 2A;

FIG. 2C is a partial cross-sectional view taken along a IIC-IIC line in FIG. 2B;

FIG. 2D is a partial cross-sectional view showing an example in which the example shown in FIG. 2A is used as a transmission unit and a receiving, unit opposed to each other;

FIG. 2E is a partial cross-sectional view made available for explanation of an operation of the example shown in FIG. 2D;

FIG. 2F is a partial cross-sectional view made available for explanation of an operation of the example shown in FIG. 2D;

FIG. 2G is a partial cross-sectional view showing a main part of a modification of the example shown in FIG. 2A;

FIG. 3A is a plan view partially showing arrays of electrode pads and protrusions used in the example shown in FIG. 2A;

FIG. 3B is a partial cross-sectional view taken along a IIIB-IIIB line in FIG. 3A;

FIG. 4 is a configuration drawing schematically showing a configuration of a modification of the example shown in FIG. 1;

FIG. 5 is a configuration drawing schematically showing a configuration of a modification of the example shown in FIG. 1;

FIG. 6 is a configuration drawing schematically showing a configuration of a modification of the example shown in FIG. 1;

FIG. 7 is a configuration drawing schematically showing a configuration of a modification of the example shown in FIG. 1;

FIG. 8 is a cross-sectional view showing a partially enlarged configuration of a modification of the example shown in FIG. 1;

FIG. 9 is a cross-sectional view showing a partially enlarged configuration of a modification of the example shown in FIG. 1;

FIG. 10 is a cross-sectional view showing a configuration of still another example of the non-contact connector according to the present invention;

FIG. 11 is a plan view showing coils used in the example shown in FIG. 10; and

FIG. 12 is a plan view showing another example of the coils used in the example shown in FIG. 10.

### DESCRIPTION OF EMBODIMENTS

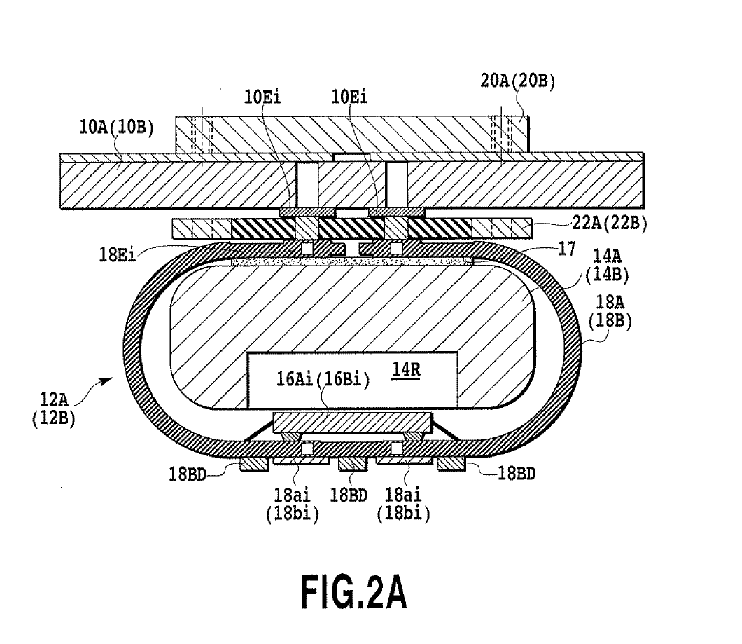

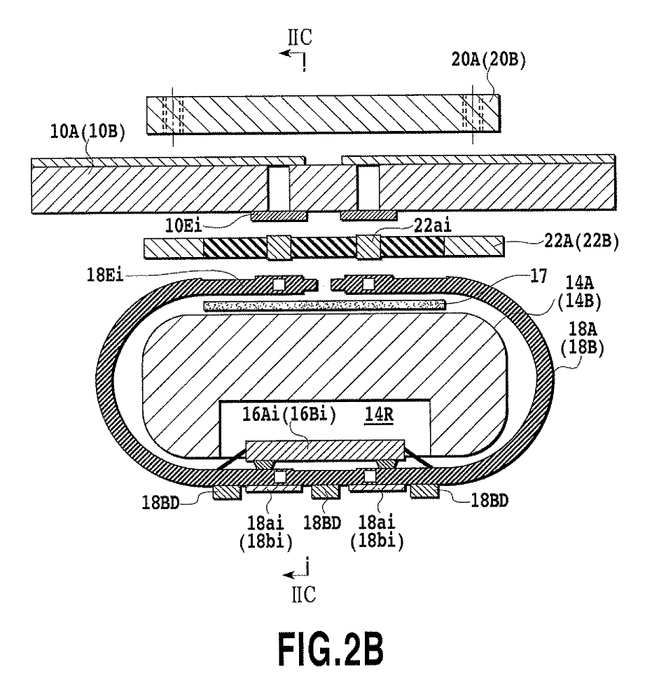

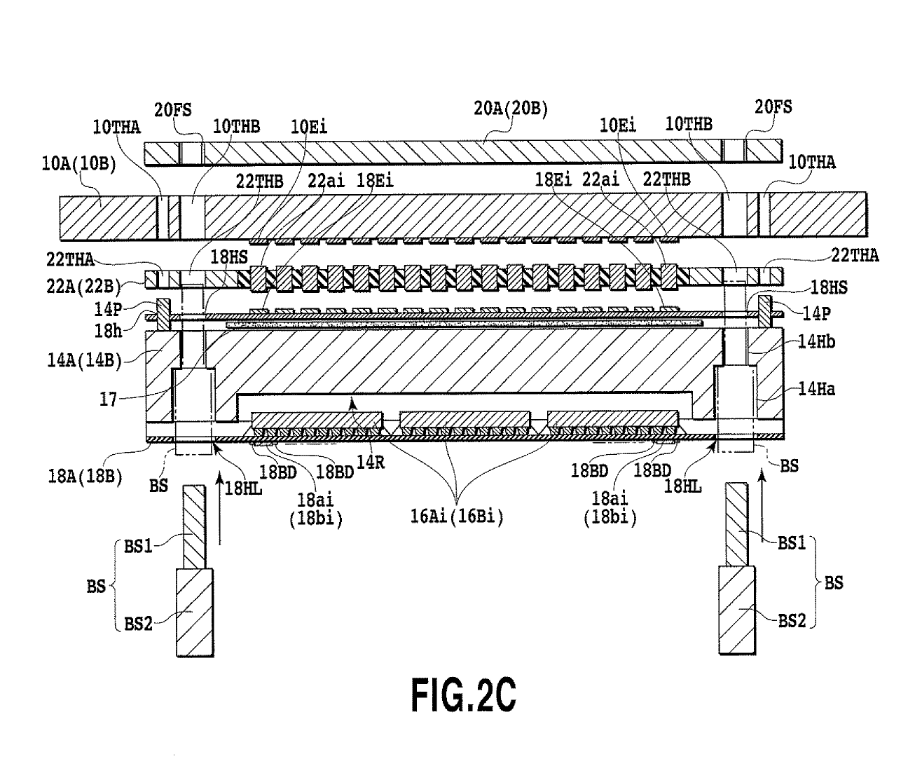

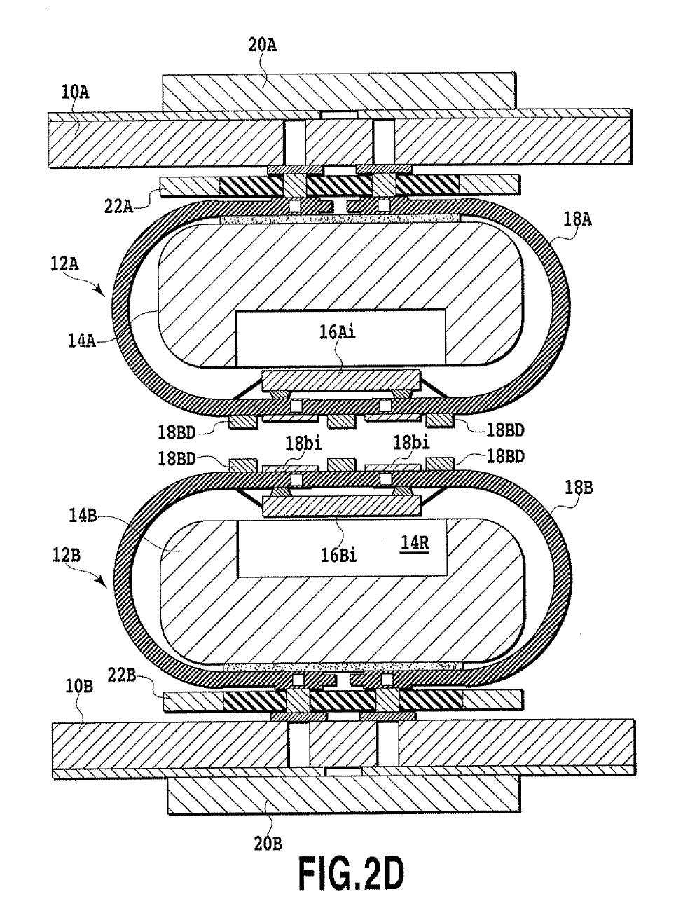

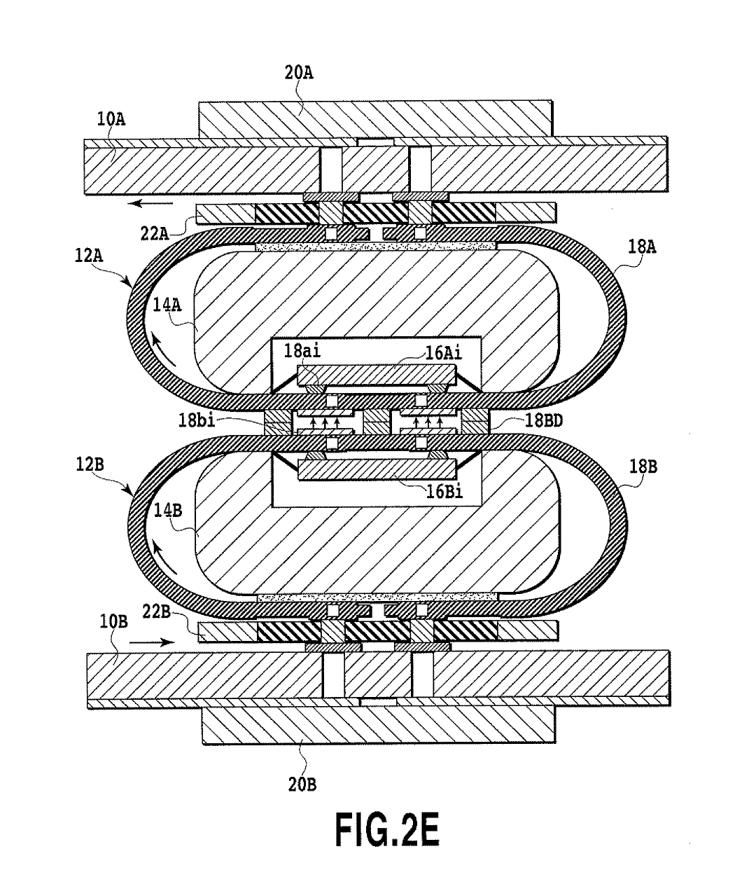

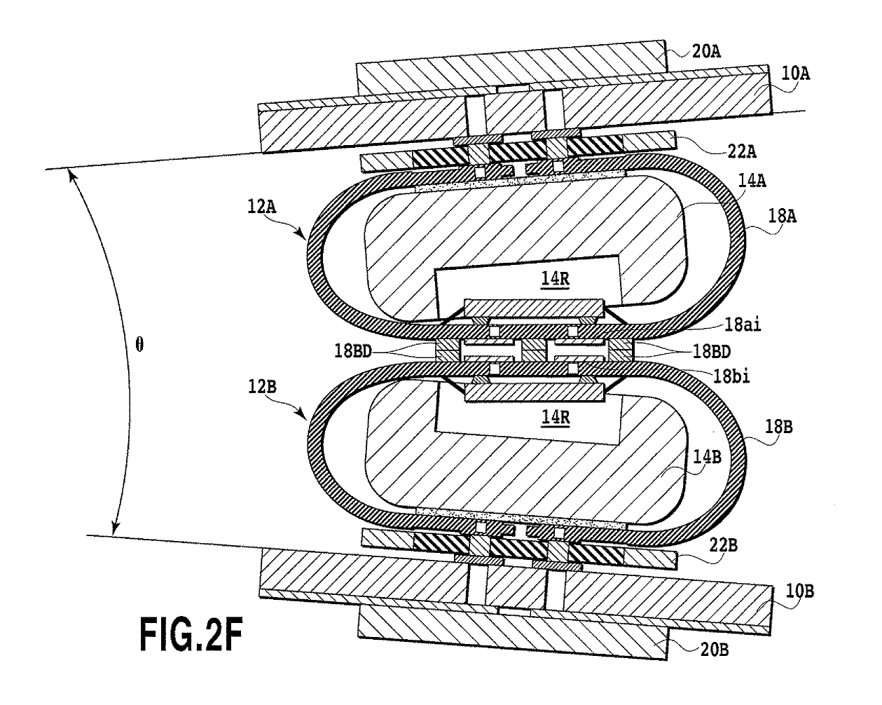

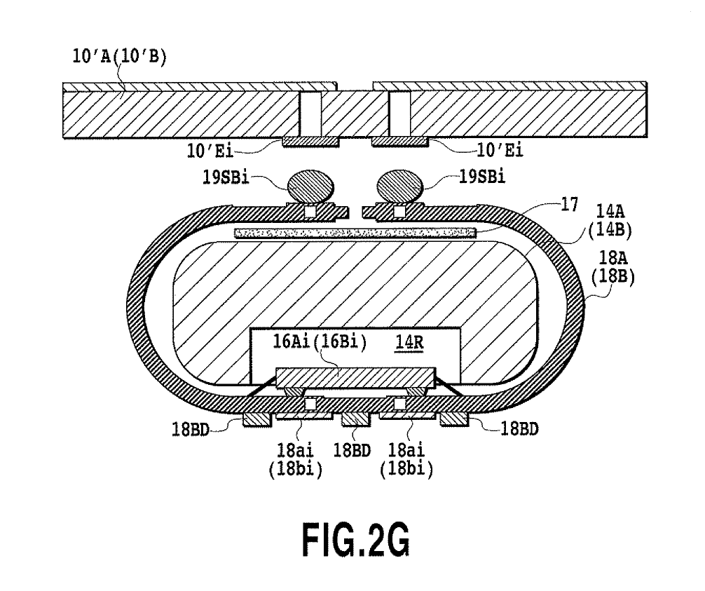

FIG. 2A shows a basic configuration of an example of a non-contact connector according to the present invention together with a wiring board. For example, the non-contact connector of a capacitive coupling type having the basic configuration as shown in FIG. 2A may be configured as a board-to-board connector configured to electrically connect wiring boards opposed to each other as described later.

In FIG. 2A, the wiring board may be a transmission side wiring board 10B or a reception side wiring board 10A, for example. The reception side wiring board 10A provided with a given wave-shaping circuit and the transmission side wiring board 10B have the same configuration except for a transmission chip and a receiving chip to be described later. Thus, the basic configuration of the reception side wiring board 10A provided with a receiving unit 12A will now be described while explanation of the transmission side wiring board 10B will be omitted.

Although illustration is omitted in FIG. 2A, the reception side wiring board 10A is provided with the given wave-shaping circuit for processing a NRZ (Non-Return-to-Zero) signal.

The receiving unit portion 12A comprises the following items as main elements, namely, a tubular flexible wiring board 18A including electrode pads 18ai (i=1 to n, n is a positive integer) as coupling components arranged on an outer surface in a matrix at given intervals, a board support 14A configured to position the flexible wiring board 18A relative to the reception side wiring board 10A and to support the board 18A, and an anisotropic conductive rubber sheet 22A placed between the board support 14A and the reception side wiring board 10A and configured to electrically connect the flexible wiring board 18A to the reception side wiring board 10A.

As shown in FIG. 2B, the anisotropic conductive rubber sheet 22A comprises conductive portions 22ai (i=1 to n, n is the positive integer) formed in positions corresponding to a group of electrode pads 18Ei (i=1 to n, n is the positive integer) of the flexible wiring board 18A and a group of electrode pads 10Ei (i=1 to n, n is the positive integer) of the reception side wiring board 10A to be described later, and an insulating base material formed around each of the conductive portions 22ai. Each of the conductive portions 22ai is formed of a composite conductive material such as anisotropic conductive rubber made of silicone rubber and metal particles. The anisotropic conductive rubber is a material having conductivity in a thickness direction thereof but not having conductivity in a direction along a flat surface thereof. Moreover, the anisotropic conductive rubber includes a dispersed type in which the conductive portions 22ai are dispersed in the rubber having the insulating property and an unevenly distributed type in which the multiple conductive portions are distributed unevenly in some parts. Any of these types is applicable. Since the conductive portions 22ai are formed of the above-described anisotropic conductive rubber, the groups of electrode pads 18Ei and 10Ei are connected to the corresponding conductive portions 22ai by surface contact. Thus, contact failures are prevented and damages caused by the contact between the groups of electrode pads 18Ei and 10Ei are prevented at the same time. The thin-plate anisotropic conductive rubber sheet 22A has relatively small through-holes 22THA at four corners thereof, which allow insertion of positioning pins 14P of the board support 14A to be described later. In the vicinity of each through-hole 22THA, a through-hole 22THB larger than the through-hole 22THA is formed adjacent thereto. A male screw portion BS1 of each fastening small screw BS to be described later is inserted to the corresponding through-hole 22THB.

The flexible wiring board 18A is a wiring board having flexibility, in which wiring made of a conductive body such as copper is formed on one or two surfaces of an insulating film made of polyimide, polyester, or the like, for example.

As shown in FIG. 2A, the flexible wiring board 18A is bent into a tubular shape in such a manner as to form a predetermined gap between the board 18A and a surface of the board support 14A. In addition, the flexible wiring board 18A is bent into a tubular shape in such a manner that two end portions thereof face each other on the anisotropic conductive rubber sheet 22A.

As shown in FIG. 2C, the group of electrode pads 18Ei composed of multiple rectangular electrode pads are formed on each of the two end portions.

Multiple through-holes 18h which allow insertion of the positioning pins 14P of the board support 14A to be described later are formed in positions placed at a predetermined distance away from the two end portions. A through-hole 18HS which allows insertion of the male screw portion BS1 of the fastening small screw BS is formed in the vicinity of each through hole 18h. In addition, as shown in FIG. 2C, a through-hole 18HL which allows insertion of a large diameter portion BS2 of the fastening small screw BS is formed in the flexible wiring board 18A in a position opposed to each through-hole 18HS. A diameter of the through-hole 18HL is set such that a given gap is formed between the through-hole 18HL and an outer peripheral portion of the large diameter portion BS2 of the fastening small screw BS.

As shown in FIG. 2C, each fastening small screw BS comprises the male screw portion BS1 to be screwed into a female screw hole 20FS provided in a reinforcing plate 20A to be described later, and the large diameter portion BS2 being connected to the male screw portion BS1 and having a larger diameter than a diameter of the male screw portion BS1.

Herewith, the group of electrode pads 18E1 (i=1 to n, n is the positive integer) of the flexible wiring board 18A are positioned relative to the board support 14A and to the conductive portions 22ai of the anisotropic conductive rubber sheet 22A when the male screw portion BS1 of each fastening small screw BS1 is caused to penetrate the through-hole 18HS in the flexible wiring board 18A, the through-hole 22THB in the anisotropic conductive rubber sheet 22A, and the through-hole 10THB in the reception side wiring board 10A via a small diameter hole 14Hb and a large diameter hole 14Ha in the board support 14A to be described later and is screwed into the female screw hole 20FS in the reinforcing plate 20A. In the meantime, an inner surface of the flexible wiring board 18A on the opposite side from the group of electrode pads thereof is attached to a surface of the board support 14A by using an adhesive film 17. Furthermore, conductive layers at the two end portions of the flexible wiring board 18A and conductive layers of the reception side wiring board 10A are electrically connected to one another via the anisotropic conductive rubber sheet 22A.

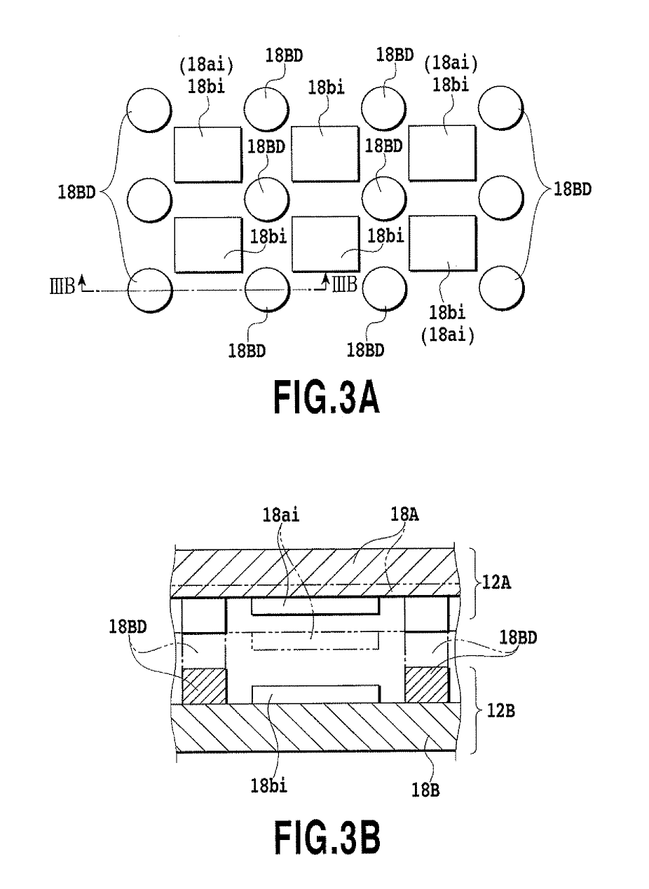

The rectangular electrode pads 18ai are formed at given intervals at a portion of an outer peripheral surface portion of the flexible wiring board 18A opposed to receiving chips 16Ai (i=1 to n, n is the positive integer) to be described later. Note that FIG. 3B shows an enlarged view of part of the group of electrode pads.

The electrode pads 18ai are electrically connected to bumps of the receiving chips 16Ai, which are flip-chip mounted on the inner surface of the flexible wiring board 18A, for example, via the conductive layers of the flexible wiring board 18A. The receiving chips 16Ai are placed at a recess 14R of the board support 14A to be described later.

As enlarged in FIG. 3A, a columnar protrusion 18BD having a predetermined height is formed in the vicinity of each corner of each electrode pad 18ai. In the case of an application to the board-to-board connector as described later, for example, when protrusions 18BD of a flexible wiring board 18B are brought into contact with upper end surfaces of the protrusions 18BD of the flexible wiring board 18A as indicated with a chain double-dashed line in FIG. 3B, multiple protrusions 18BD configured to limit a gap between the above-mentioned electrode pads 18ai and electrode pads 18bi at a predetermined value are formed in the longitudinal and transverse directions between the electrode pads 18bi as gap limiting means.

The board support 14A formed of a resin material has the recess 14R placed at one end portion and configured to house the receiving chips 16Ai which are fixed to the flexible wiring board 18A. The recess 14R is open toward the flexible wiring board 18A. When the flexible wiring board 18A moves due to its elasticity and comes close to the board support 14A as will be described later, the recess 14R prevents the receiving chips 16Ai from contact with the board support 14A. In addition, the flexible wiring board 18A can move due to its elasticity until the board 18A comes into contact with the board support. Thus, it is possible to increase an amount of mobility of the flexible wiring board 18A. In addition, the board support 14A has the multiple positioning pins 14P which are integrally formed at given intervals at end portions of the board support 14A. A tip of each positioning pin 14P is inserted into the through-hole 10THA via the through-hole 18h in the flexible wiring board 18A and the through-hole 22THA in the anisotropic conductive rubber sheet 22A. The through-hole 10THA is provided in a position adjacent to the through-hole 10THB in the reception side wiring board 10A.

The reinforcing plate 20A is provided on a surface of the reception side wiring board 10A on the opposite side from another surface where the anisotropic conductive rubber sheet 22A is placed. The reinforcing plate 20A is fixed to the reception side wiring board 10A as the above-mentioned male screw portions BS1 of the fastening small screws BS are screwed into the female screw holes 20FS in the plate 20A. The reinforcing plate 20A is provided for the purpose of decreasing flexure of the reception side wiring board 10A which occurs at the time of fastening in order to reduce instability in electrical connection of the anisotropic conductive rubber sheet 22A attributed to the flexure of the board. Accordingly, the reinforcing plate 20A can be omitted when the reception side wiring board 10A is thick enough that the flexure at the time of fastening is ignorable.

In the above-described example, the anisotropic conductive rubber sheet 22A is used for the purpose of making the reception side wiring board 10A and the receiving unit 12A detachable. However, the present invention is not limited only to this example. When the detachment is not required, instead of the anisotropic conductive rubber sheet 22A, solder balls 19SBi (i=1 to n, n is the positive integer) may be formed on the two end portions of the flexible wiring board 18A as shown in FIG. 2G, for example, and conductive layers 10′Ei (i=1 to n, n is the positive integer) of a reception side wiring board 10′A or a transmission side wiring board 10′B may be soldered to the two end portions of the flexible wiring board 18A by means of the solder balls 19SBi. The anisotropic conductive rubber sheet 22A, the reinforcing plate 20A (20B), and the through-holes 10THB are therefore unnecessary in this case.

In FIG. 2D, the example of the non-contact connector according to the present invention is configured as the board-to-board connector of the capacitive coupling type, for instance, and is configured to electrically connect the reception side wiring board 10A to the transmission side wiring board 10B, which are respectively provided with the receiving unit 12A and the transmission unit 12B described above.

The reception side wiring board 10A and the transmission side wiring board 10B are supported in such a manner as to be movable to and away from each other by means of an unillustrated support mechanism. Although illustration is omitted, the reception side wiring board 10A is provided with the given wave-shaping circuit for processing a NRZ (Non-Return-to-Zero) signal.

The non-contact connector comprises the receiving unit portion 12A provided on one of surfaces of the reception side wiring board 10A, and the transmission unit portion. 12B provided on the surface of the transmission side wiring board 10B opposed to the reception side wiring board 10A.

The receiving unit portion 12B comprises the following items as main elements, namely, the tubular flexible wiring board 18B including the electrode pads 18bi (i=1 to n, n is the positive integer) as coupling components arranged on an outer surface in a matrix at given intervals, a board support 14B configured to position the flexible wiring board 18B relative to the transmission side wiring board 10B and to support the board 18B, and an anisotropic conductive rubber sheet 22B placed between the board support 14B and the transmission side wiring board 10B and configured to electrically connect the flexible wiring board 18B to the transmission side wiring board 10B.

The structures of the flexible wiring board 18B, the board support 14B, the anisotropic conductive rubber sheet 22B, and a reinforcing plate 20B are the same as the structures of the flexible wiring board 18A, the board support 14A, and the anisotropic conductive rubber sheet 22A described above, respectively, and duplicate explanation will therefore be omitted.

Transmission chips 16Bi (i=1 to n, n is the positive integer) are placed at a recess 14R of the board support 14B. The board support 14B formed of a resin material has the recess 14R placed at one end portion and configured to house the transmission chips 16Bi which are flip-chip mounted on the flexible wiring board 18B. The recess 14R is open toward the flexible wiring board 18B.

In the above-described configuration, as shown in FIG. 2E and FIG. 3B, the receiving unit portion 12A and the transmission unit portion 12B are brought close to each other and then the upper end surfaces of the protrusions 18BD of the flexible wiring board 18A are brought into contact with upper end surfaces of protrusions 18BD of the flexible wiring board 18B at a given pressure attributed to elastic forces of the flexible wiring boards 18A and 18B. In this case, when a group of given NRZ signals are supplied to the transmission side wiring board 10B in a direction indicated with an arrow in FIG. 2E, the signals are supplied to the transmission chips 16Bi via the flexible wiring board 18B. Accordingly, the group of signals outputted from the transmission chips 16Bi are supplied to the receiving chips 16Ai via the electrode pads 18bi and the electrode pads 18ai. At that time, the gap between the electrode pads 18bi and the electrode pads 18ai is limited at a predetermined value by the pairs of protrusions 18BD opposed to one another. Therefore, it is possible to keep the mutual distance between the opposed electrode portions constant so as to hold a steady and good quality of the transmitted signals.

Then, the group of signals outputted from the receiving chips 16Ai are transmitted through the flexible wiring board 18A in a direction indicated with another arrow in FIG. 2E, and are supplied to the wave-shaping circuit (not shown) and the like in the reception side wiring board 10A.

In addition, even when the reception side wiring board 10A is inclined in such a manner as to cross the transmission side wiring board 10B at a given angle θ as shown in. FIG. 2F, each electrode pad 18bi and the corresponding electrode pad 18ai can maintain the predetermined distance with the assistance of the protrusions 18BD by applying the above-described configuration as long as the flexible wiring boards 18A and 18B remain within elastically movable ranges thereof. Thus, it is apparent that the signal transmission quality can be stabilized by ensuring a predetermined gap without relying on mechanical accuracy.

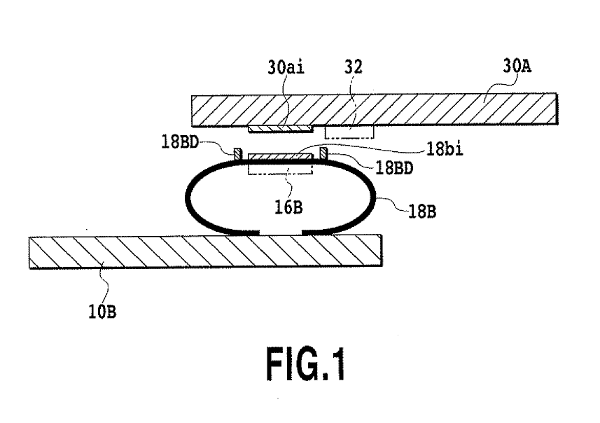

In the above-described example, the receiving chips 16Ai and the transmission chips 16Bi are fixed to their respective flexible wiring boards 18A and 18B having flexibility and elasticity. However, the present invention is not necessarily limited to this configuration. For example, in a reception side wiring board 30A, an electrode pad 30ai and a receiving chip 32 may be arranged on the reception side wiring board 30A adjacent to each other as shown in FIG. 1 without using a flexible wiring board. Note that FIG. 1 representatively shows the single electrode pad 18bi, the single electrode pad 30ai, and the two protrusions 18BD while illustration of the above-described board support, anisotropic conductive rubber sheet, and the like is omitted therein.

In this case, when the receiving unit portion and the transmission unit portion are brought close to each other and then the upper end surfaces of the protrusions 18BD are brought into contact with the surface of the reception side wiring board 30A at a given pressure attributed to the elastic force of the flexible wiring board 18B, the gap between the electrode pad 18bi and the electrode pad 30ai is limited at a predetermined value by the protrusions 18BD. In addition, even when the reception side wiring board 30A is inclined with respect to the transmission side wiring board 10B, it is possible to maintain the mutual distance between the opposed electrode portions constant so as to hold a steady and good quality of the transmitted signal as long as the flexible wiring board 18B remains within an elastically movable range thereof.

In the examples shown in FIG. 1 and FIG. 2A to FIG. 2G, the protrusions 18BD at the transmission unit portion are brought into contact with the flexible wiring board or the surface of the reception side wiring board 30A. by the pressure based on the elastic force of at least one tubular flexible wiring board serving as elastic means. However, the present invention is not limited only to this example. For instance, as schematically shown in FIG. 4, protrusions 42BD serving as the above-described gap limiting means may be brought into contact with a surface of a reception side wiring board 40A at a given pressure attributed to an elastic force of a coil spring 44 that serves as the elastic means.

In the example shown in FIG. 4, the non-contact connector comprises a transmission side unit portion provided on a transmission side wiring board 40B, and a reception side unit portion provided on the reception side wiring board 40A.

Note that illustration of components of the reception side unit portion including receiving chips and the like is omitted in FIG. 4 with the exception of an electrode pad 40ai. In addition, illustration of components of the transmission side unit portion including transmission chips and the like is also omitted with the exception of an electrode pad 42bi. Further, the single electrode pad 42bi, the single electrode pad 40ai, and the two protrusions 42BD are representatively shown while illustration of the above-described board support and a fixation plate is omitted.

In FIG. 4, an unillustrated transmission chip is fixed to a band-shaped flexible wiring board 42 of which one end portion is electrically connected to the transmission side wiring board 40B. The electrode pad 42bi to be electrically connected to the transmission chip is provided on another end portion of the band-shaped flexible wiring board 42 and opposed to the electrode pad 40ai of the reception side wiring board 40A. In addition, the protrusions 42BD serving as the above-described gap limiting means are formed around the electrode pad 42bi on the other end portion of the flexible wiring board 42.

In addition, the coil spring 44 configured to bias the other end portion of the flexible wiring board 42 so as to bring the other end portion close to the reception side wiring board 40A is placed between a surface of the flexible wiring board 42 at the other end portion and a surface of the transmission side wiring board 40B.

In the above-described configuration, when the receiving unit portion and the transmission unit portion are brought close to each other and then upper end surfaces of the protrusions 42BD are brought into contact with the surface of the reception wiring board 40A at a given pressure attributed to an elastic force of the coil spring 44, a gap between the electrode pad 42bi and the electrode pad 40ai is limited at a predetermined value by the protrusions 42BD. Therefore, it is possible to keep the mutual distance between the opposed electrode portions constant so as to hold a steady and good quality of a transmitted signal.

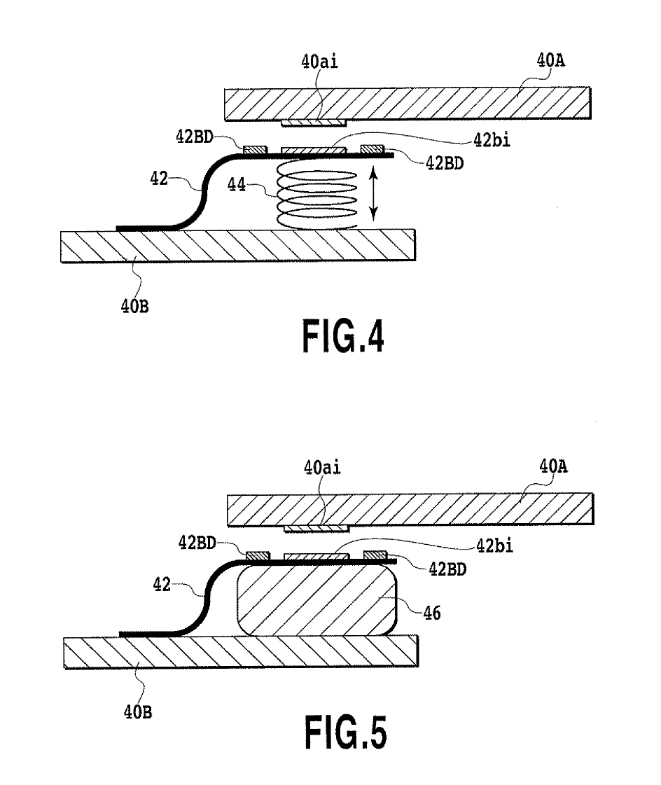

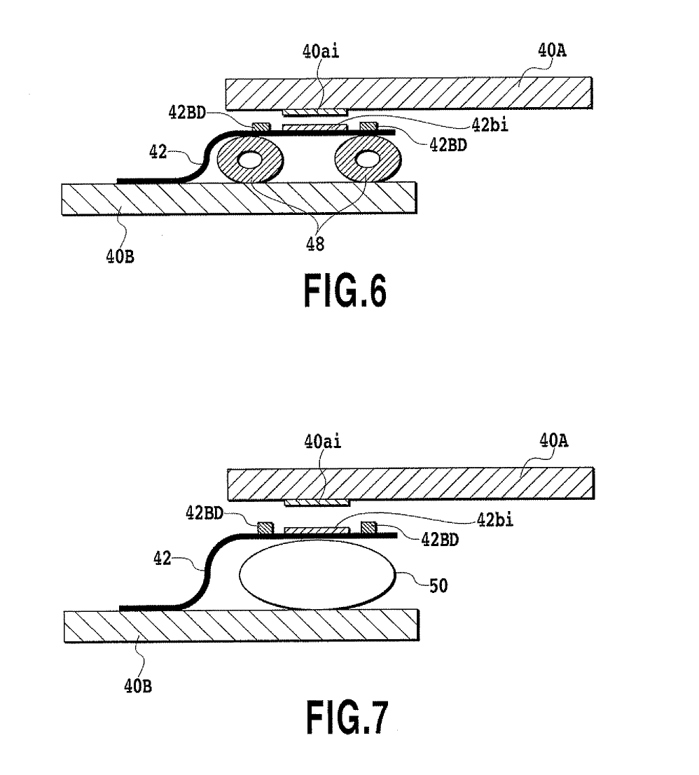

In the example shown in FIG. 4, the coil spring 44 configured to bias the other end portion of the flexible wiring board 42 so as to bring the other end portion close to the reception side wiring board 40A is placed between the surface of the flexible wiring board 42 at the other end portion and the surface of the transmission side wiring board 40B. However, the present invention is not limited only to this example. For instance, as respectively shown in FIG. 5, FIG. 6, and FIG. 7, any of an elastic body 46 formed of a gel, an elastomer or the like, a pair of tubular pipe members 48 formed of a rubber material, and a film body 50 formed into a substantially spherical shape using a thin film may be used as the elastic means instead of the coil spring 44.

Note that in FIG. 5 to FIG. 7, the same constituents as those shown in FIG. 1 will be denoted by the same reference signs and duplicate explanation thereof will be omitted.

In the examples shown in FIG. 1 to FIG. 7, the protrusions serving as the gap limiting means are formed on the flexible wiring board or boards. However, the present invention is not necessarily limited to these configurations. For instance, as shown in FIG. 8, it is possible to apply a configuration in which a film 52 having a given thickness is arranged as the gap limiting means between an electrode pad 50ai of a reception side wiring board 50A formed of a flexible wiring board and an electrode pad 50bi of a transmission side wiring board 50B formed of a flexible wiring board without providing the above-described protrusions. In this case, two end portions of the film 52 may be supported by the above-described flexible wiring boards, for example.

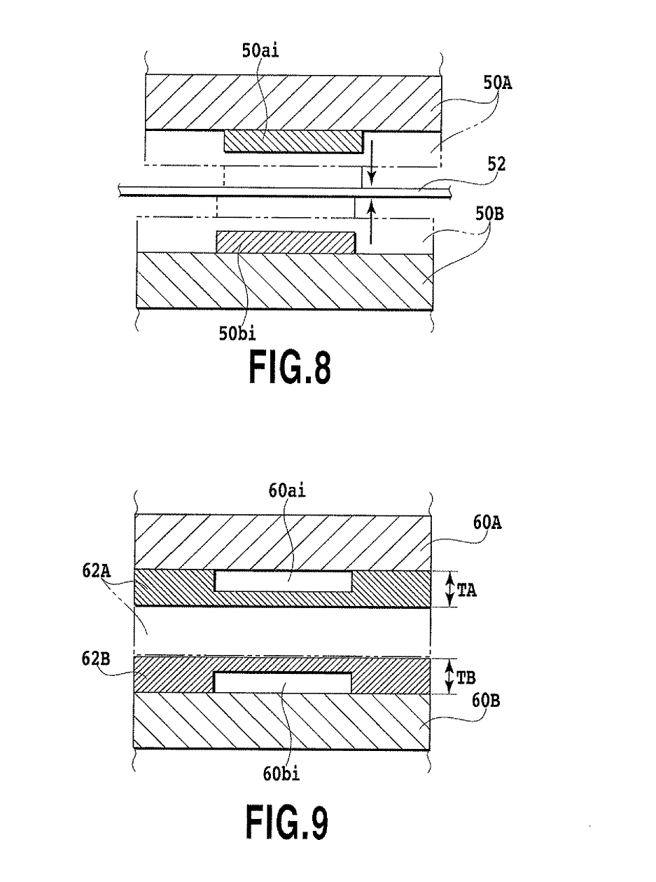

Further, as shown in FIG. 9, an electrode pad 60ai of a reception side wiring board 60A may be covered with a solder resist layer 62A serving as a dielectric body without providing the above-described protrusions. In this case, a thickness TA of the solder resist layer 62A coating a surface of the reception side wiring board 60A is set slightly greater than a thickness of the electrode pad 60ai.

Similarly, an electrode pad 60bi of a transmission side wiring board 60B may be covered with a solder resist layer 62B serving as a dielectric body. In this case, a thickness TB of the solder resist layer 62B coating a surface of the transmission side wiring board 60B is set slightly greater than a thickness of the electrode pad 60bi. Hereby, the solder resist layer 62A and the solder resist layer 62B serving as the gap limiting means can be integrated with the electrode pads 60ai and 60bi.

In addition, when the solder resist layer 62A and the solder resist layer 62B are brought into contact with each other as indicated with a chain double-dashed line in FIG. 9, a mutual distance between the electrode pad 60ai and the electrode pad 60bi is maintained accurately at a predetermined value.

Accordingly, the example of the non-contact connector of the capacitive coupling type according to the present invention achieves less power consumption and less influences to surrounding circuits. Moreover, the use of the gap limiting means makes it possible to maintain the mutual distance between the electrode pads at a predetermined value without causing a fluctuation.

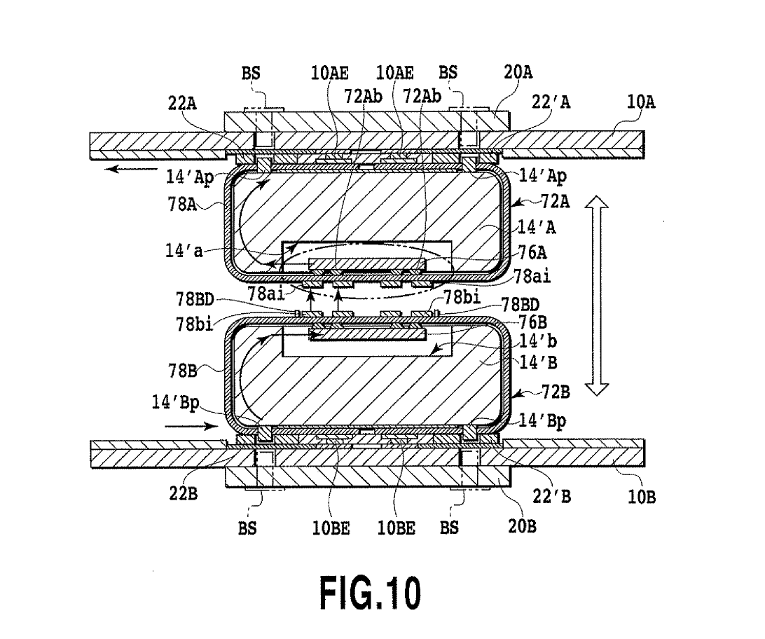

FIG. 10 shows a configuration of another example of the non-contact connector according to the present invention together with wiring boards to be placed opposite to each other.

In FIG. 10, the non-contact connector is configured as a board-to-board connector of an electromagnetic induction coupling type, for example, in which the transmission side wiring board 10B is electrically connected to the reception side wiring board 10A. Note that in FIG. 10, the same constituents as those in the examples shown in FIG. 2A to FIG. 2G will be denoted by the same reference signs and duplicate explanation thereof will be omitted.

The reception side wiring board 10A and the transmission side wiring board 10B are supported in such a manner as to be movable to and away from each other by means of an unillustrated support mechanism. Although illustration is omitted, the reception side wiring board 10A is provided with a given wave-shaping circuit for processing a pulse signal.

The non-contact connector comprises a receiving unit portion 72A provided on one of surfaces of the reception side wiring board 10A, and a transmission unit portion 72B provided on the surface of the transmission side wiring board 10B opposed to the reception side wiring board 10A.

The receiving unit portion 72A comprises a tubular flexible wiring board 78A including looped coils 78ai (i=1 to n, n is a positive integer) as coupling components arranged on an outer surface in a matrix at given intervals, a board support 14′A configured to position the flexible wiring board 78A relative to the reception side wiring board 10A and to support the board 78A, and a fixation plate 22′A configured to fix the board support 14′A and the flexible wiring board 78A to the reception side wiring board 10A.

The flexible wiring board 78A is a wiring board having flexibility, in which wiring made of a conductive body such as copper is formed on one or two surfaces of an insulating film made of polyimide, polyester, or the like, for example.

The flexible wiring board 78A is bent into a tubular shape in such a manner that two end portions thereof face each other on the fixation plate 22′A. Multiple through-holes which allow insertion of positioning pins 14′Ap of the board support 14′A to be described later are formed in positions placed at a predetermined distance away from the two end portions. A group of electrode pads of the flexible wiring board 78A are thereby positioned relative to the board support 14′A. In addition, conductive layers on the two end portions are respectively soldered to connection terminal portions provided on the fixation plate 22′A.

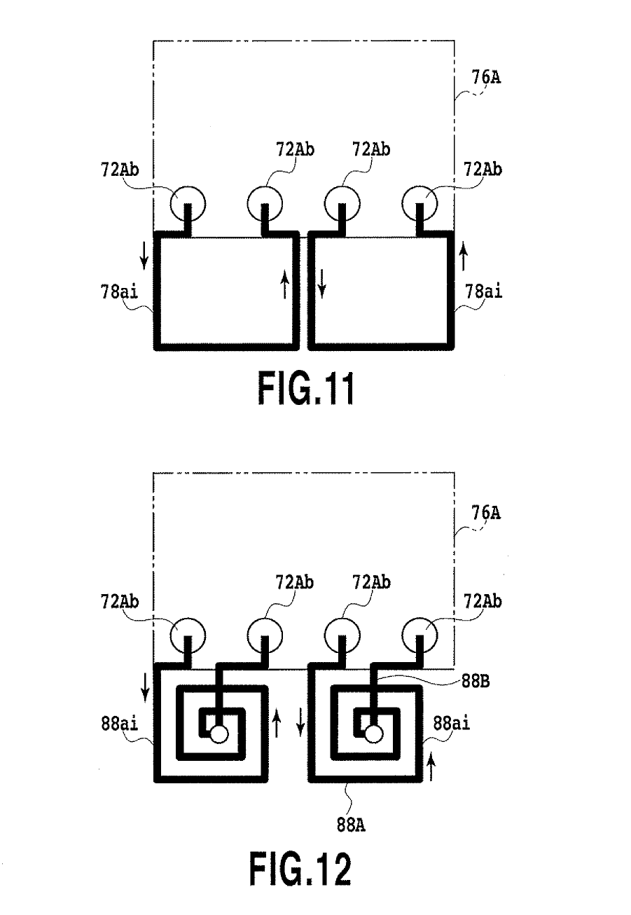

The looped coils 78ai are formed at given intervals at a portion of the flexible wiring board 78A opposed to the transmission unit portion 72B. As enlarged in FIG. 11, two ends of each of the coils 78ai arranged mutually in parallel at the given intervals are connected to are connected to a receiving chip 76A to be described later through bumps 72Ab. A current is supplied to each coil 78ai in a direction indicated with arrows in FIG. 11. On the other hand, a current is supplied to each coil 78bi in the reverse direction to the direction indicated with the arrows.

The coils 78ai are electrically connected to bumps of the receiving chip 76A arranged on an inner surface of the flexible wiring board 78A via the conductive layers of the flexible wiring board 78A. The receiving chip 76A is placed in a recess 14′a of the board support 14′A.

The transmission unit portion 72B comprises a tubular flexible wiring board 78B including looped coils 78bi (i=1 to n, n is the positive integer) as coupling components arranged on an outer surface at given intervals, a board support 14′B configured to position the flexible wiring board 78B relative to the transmission side wiring board 10B and to support the board 78B, and a fixation plate 22B configured to fix the board support 14′B and the flexible wiring board 78B to the transmission side wiring board 10B.

The flexible wiring board 78B having flexibility and elasticity adopts a similar configuration to that of the flexible wiring board 78A.

The flexible wiring board 78B is bent into a tubular shape in such a manner that two end portions thereof face each other on the fixation plate 22B. Multiple through-holes which allow insertion of positioning pins 14′Bp of the board support 14′B are formed in positions placed at a predetermined distance away from the two end portions. A group of electrode pads of the flexible wiring board 78B are thereby positioned relative to the board support 14′B. In addition, conductive layers on the two end portions are respectively soldered to connection terminal portions provided on the fixation plate 22′B.

The looped coils 78bi having a similar shape to that of the coils 78ai are formed at given intervals at a portion of the flexible wiring board 78B opposed to the receiving unit portion 72A.

The coils 78bi are electrically connected to bumps of a transmission chip 76B arranged on an inner surface of the flexible wiring board 78B via the conductive layers of the flexible wiring board 78B.

Columnar protrusions 78BD having a predetermined height are respectively formed in lateral positions adjacent to the coils 78bi. Accordingly, the multiple protrusions 78BD are formed in a matrix on a common plane of the flexible wiring board 78B. Furthermore, the multiple protrusions 78BD serve as the gap limiting means and control a gap between the above-mentioned coils 78ai and coils 78bi at a predetermined value when a surface of the flexible wiring board 78A is brought into contact with upper end surfaces of the protrusions 78BD. The transmission chip 76B is placed in a recess 14′b of the board support 14′B.

Note that the present invention is not limited only to this example. For instance, the multiple protrusions 78BD may also be provided on the receiving unit portion 72A as similar to the example shown in FIG. 2D.

In the above-described configuration, in the case where the receiving unit portion 72A and the transmission unit portion 72B are brought close to each other and then the upper end surfaces of the protrusions 78BD are brought into contact with the flexible wiring board 78A at a given pressure attributed to elastic forces of the flexible wiring boards 78A and 78B, a group of given pulse signals are supplied to the transmission chip 16Bi via the flexible wiring board 78B when the signals are supplied to the transmission side wiring board 10B in a direction indicated with an arrow in FIG. 10. Accordingly, an induction current, which is formed by the coils 78bi and the coils 78ai opposed to one another by electromagnetic induction using the group of signals outputted from the transmission chip 76B, is supplied as reception signals to the receiving chip 76A. At that time, the gap between the coils 78bi and the coils 78ai is limited at the predetermined value by the protrusions 78BD. Thus, it is possible to keep the mutual distance between the opposed electrode portions constant so as to hold a steady and good quality of the transmitted signals.

Then, the group of pulse signals outputted from the receiving chip 76A are transmitted through the flexible wiring board 78A in a direction indicated with other arrows in FIG. 10, and are supplied to a wave-shaping circuit (not shown) and the like in the reception side wiring board 10A.

The shape of the coils 78bi and the coils 78ai is not limited only to this example. For instance, as enlarged in FIG. 12, coils 88ai and coils 88bi (not shown) placed respectively at the receiving unit portion 72A and the transmission unit portion 72B in such a manner to be opposed to one another may be formed into a shape of a spiral pattern or a fret pattern. Note that in FIG. 12, the same constituents as those shown in FIG. 11 will be denoted by the same reference signs and duplicate explanation thereof will be omitted.

In FIG. 12, the shape of the coils 88ai is the same as the shape of the coils 88bi. Thus, the coil 88ai will be described below while explanation on the coil 88bi will be omitted.

In FIG. 12, each coil 88ai comprises a portion 88A having an end connected to one of bumps 72Ab and being formed on the same plane into a counterclockwise fret pattern that includes segments placed close to one another, and a portion 88B having an end connected to another bump 72Ab and intersecting the portion 88A. In the above-described configuration, a current is supplied in a direction indicated with arrows in FIG. 12. On the other hand, a current is supplied to each coil 88bi in the reverse direction to the direction indicated with the arrows.

Herewith, the signals can be transmitted even when the interval between the coils 88ai and the coils 88bi, which are placed respectively on the receiving unit portion 72A and the transmission unit portion 72B in such a manner as to be opposed to one another, is greater than the interval between the coils 78bi and the coils 78ai, which are arranged respectively on the receiving unit portion 72A and the transmission unit portion 72B in such a manner as to be opposed to one another in the example shown in FIG. 11. In this way, it is possible to improve reliability of signal transmission.

Note that in the case of the above-described electromagnetic induction coupling type as well, the gap limiting means shown in FIG. 1 and FIG. 4 to FIG. 7 may be applied to the example of the electromagnetic induction coupling type by providing the coils, the receiving chip, and the transmission chip described above instead of the electrode pads, the receiving chips, and the transmission chips in the examples of the capacitive coupling type shown in FIG. 1 and FIG. 4 to FIG. 7. In addition, the example of the non-contact connector according to the present invention is applied to the board-to-board connector in the above-described example. However, the present invention is not limited only to this example. For instance, the present invention is by all means applicable to other devices such as a probe card connector.

### REFERENCE SIGNS LIST

12A, 72A RECEIVING UNIT PORTION
12B, 72B TRANSMISSION UNIT PORTION
16Ai, 76A RECEIVING CHIP
16Bi, 76B TRANSMISSION CHIP
18A, 18B, 42, 78A, 78B FLEXIBLE WIRING BOARD
18ai, 18bi ELECTRODE PAD
18BD, 78BD PROTRUSION
78ai, 78bi, 88ai COIL

1. A non-contact connector comprising:
a transmission unit portion configured to transmit a supplied group of signals via a transmission chip and a coupling component; and
a receiving unit portion configured to receive the group of signals from the transmission unit portion via a coupling component and a receiving chip,
wherein the coupling component of at least one of the transmission unit portion and the receiving unit portion is formed on a flexible wiring board placed between the transmission chip and the receiving chip, the flexible wiring board connected to one of the transmission chip and the receiving chip, and biased in one direction by elastic means, and
the flexible wiring board is provided with gap limiting means for limiting a gap between the coupling component of the transmission unit portion and the coupling component of the receiving unit portion at a predetermined distance.

2. The non-contact connector according to claim 1, the coupling components of the transmission unit portion and the receiving unit portion are formed on flexible wiring boards each placed between the transmission chip and the receiving chip, the flexible wiring boards connected to one of the transmission chip and the receiving chip, and biased in one direction by the elastic means.

3. The non-contact connector according to claim 1, the elastic means is the flexible wiring board bent into a tubular shape.

4. The non-contact connector according to claim 3,
the flexible wiring board is supported by a board support, and
a gap is formed between the flexible wiring board and a surface of the board support.

5. The non-contact connector according to claim 4, a recess configured to accommodate one of the transmission chip and the receiving chip is formed in the board support.

6. The non-contact connector according to claim 1, the coupling components are electrode pads used in the transmission unit portion and the receiving unit portion of a capacitive coupling type.

7. The non-contact connector according to claim 1, the coupling components are coils used in the transmission unit portion and the receiving unit portion of an electromagnetic induction coupling type.
